(19) United States
(12) Patent Application Publication
(10) Pub. No.: US 2013/0039806 A1
(43) Pub. Date: Feb. 14, 2013

(54) NANOWIRE PURIFICATION METHODS, COMPOSITIONS, AND ARTICLES

(71) Applicants: Jeffrey Blinn, Rochester, NY (US); Doreen C. Lynch, Afton, MN (US); Karissa L. Eckert, Blaine, MN (US); Eric L. Dillenbeck, Rochester, NY (US)

(72) Inventors: Jeffrey Blinn, Rochester, NY (US); Doreen C. Lynch, Afton, MN (US); Karissa L. Eckert, Blaine, MN (US); Eric L. Dillenbeck, Rochester, NY (US)

(21) Appl. No.: 13/553,923

(22) Filed: Jul. 20, 2012

Related U.S. Application Data
(60) Provisional application No. 61/522,779, filed on Aug. 12, 2011.

(51) Int. Cl. C22C 5/06; B01D 61/14; C09K 3/00; B82Y 40/00; B82Y 30/00

(52) U.S. Cl. 420/501; 210/650; 252/1; 977/762; 977/900

(57) ABSTRACT

Processes are disclosed and claimed that allow either purification of nanowire slurries or exchange of liquids in such slurries or both. Such processes avoid the drawbacks of other known methods and are readily scalable to larger production volumes.

### CROSS REFERENCE TO RELATED APPLICATIONS

This application claims the benefit of U.S. provisional application No. 61/522,779, filed Aug. 12, 2011, entitled NANOWIRE PURIFICATION METHODS, COMPOSITIONS, AND ARTICLES, which is hereby incorporated by reference in its entirety.

### BACKGROUND

The general preparation of high aspect ratio (e.g., 10-200 aspect ratio) nanowires is known. For example, Y. Xia, Y. Xiong, B. Lim, and S. E. Skrabalak, Angew. Chem. Int. Ed., 2009, 48, 60, which is hereby incorporated by reference in its entirety, discloses preparation of silver nanowires. This and other similar preparation methods generally produce a product slurry that contains the desired high aspect ratio nanomaterial, along with undesired solid contaminants (e.g., shorter wires, nanoparticles, and/or other non-wire nanomaterials) and liquids and soluble chemicals that may not be compatible with downstream processes. By increasing the purity of nanowire slurries, optical and electrical properties of articles comprising such nanowires may be improved.

Purification methods are known that attempt to reduce the levels of undesired solid contaminants and/or displace liquids in the product slurry with liquids that are more compatible with downstream processes. However, such methods are not generally suitable at scales larger than the lab bench. For example, U.S. patent application publications 2011/0045272 by Allemand and 2009/0282948 by Miyagishima et al. describe sedimentation and centrifugation. The productivity of sedimentation can be limited by the long settling times required for adequate separation. Large-scale centrifugation can require significant capital investments. Normal-flow filtration methods are also known. See, for example, PCT publication WO 2010/150619 by Konica. In such methods, materials can accumulate upstream. “blinding” the filter media, and possibly deforming the nanowires. Use of filtration aids to attempt to improve the situation can add additional, sometimes quite difficult, steps of separating the nanowires from the filtration aid. Lab-scale ultrafiltration is described in, for example, U.S. patent application publication 2010/0078197. Alternative filtration methods have been proposed that attempt to filter impurities through large-sized filter media pores or to induce nanowires to flow length-wise through small-sized apertures, trapping impurities upstream. See, for example, U.S. patent application publication 2010/0321364 by Spaid, et al., which is hereby incorporated by reference in its entirety.

### SUMMARY

Applicants have developed processes that allow either purification of nanowire slurries or exchange of liquids in such slurries or both. Such processes avoid the drawbacks of other known methods and are readily scalable to larger production volumes.

At least one first embodiment provides methods comprising providing a first feed composition comprising nanowires, at least one first liquid, and at least one solid contaminant; providing at least one filter element comprising at least one inlet, at least one outlet, and at least one semi-permeable membrane comprising a plurality of pores therethrough, said plurality of pores comprising a mean pore diameter less than about 0.5 μm; feeding the first feed composition to the at least one inlet of the at least one filter element; and producing a retentate composition comprising nanowires from the at least one outlet of the at least one filter element, where the solid fraction of nanowires in the retentate composition is greater than the solid fraction of nanowires in the feed composition.

The at least one filter element may, in some cases, comprise at least one of a flat plate filter element, a spiral wound filter element, or a hollow fiber filter element. The plurality of pores may, in some cases, comprise a mean pore size greater than about 0.05 μm. or greater than about 0.01 μm, or about 0.2 μm, or about 0.02 μm. The nanowires in the feed composition may, in some cases, comprise a mean length greater than about 10 μm.

In at least one second embodiment, such methods may further comprise producing a permeate composition comprising material having passed through the plurality of pores of the at least one semi-permeable membrane. Such a permeate may, in at least some cases, comprise a solid fraction of nanowires that is less than the solid fraction of nanowires in the feed composition.

In at least one third embodiment, such methods may further comprise displacing at least some of the at least one first liquid with at least one second liquid. In some cases, at least about 90% of the at least one first liquid may be displaced by the at least one second liquid.

In at least one fourth embodiment, producing the retentate composition may further comprise controlling at least one retentate flow-rate.

In at least one fifth embodiment, such methods may further comprise filtering a second feed composition to provide the first feed composition.

Other embodiments provide the retentate produced according to such methods.

Still other embodiments provide the nanowires of the retentate produced according to such methods.

Yet still other embodiments provide articles comprising the nanowires of the retentate produced according to such methods.

These embodiments and other variations and modifications may be better understood from the brief description of the drawings, description, exemplary embodiments, examples, drawings, and claims that follow. Any embodiments provided are given only by way of illustrative example. Other desirable objectives and advantages inherently achieved may occur or become apparent to those skilled in the art.

### BRIEF DESCRIPTION OF THE DRAWING

FIG. 1 shows a micrograph of the cross-flow filtered permeate of Example 5.

FIG. 2 shows a micrograph of the centrifuge-purified dispersion of Example 6.

FIG. 3 shows a micrograph of the cross-flow filtered permeate of Example 7.

### DESCRIPTION

All publications, patents, and patent documents referred to in this document are incorporated by reference herein it their entirety, as though individually incorporated by reference.

U.S. provisional application No. 61/522,779, filed Aug. 12, 2011, entitled NANOWIRE PURIFICATION METHODS, COMPOSITIONS, AND ARTICLES, is hereby incorporated by reference in its entirety.

### Feed Composition Comprising Nanowires

In some embodiments, a feed composition is provided that comprise nanowires. Nanowires are an example of one-dimensional nanostructures. Nanostructures are structures having at least one “nanoscale” dimension less than 300 nm, and at least one other dimension being much larger than the nanoscale dimension, such as, for example, at least about 10 or at least about 100 or at least about 200 or at least about 1000 times larger. Examples of such nanostructures are nanorods, nanowires, nanotubes, nanopyramids, nanoprisms, nanoplates, and the like. “One-dimensional” nanostructures have one dimension that is much larger than the other two dimensions, such as, for example, at least about 10 or at least about 100 or at least about 200 or at least about 1000 times larger.

Nanowires are one-dimensional nanostructures in which the two short dimensions (the thickness dimensions) are less than 300 nm, preferably less than 100 nm, while the third dimension (the length dimension) is greater than 1 micron, or greater than 2 microns, or greater than 5 microns, or greater than 10 microns, and the aspect ratio (ratio of the length dimension to the larger of the two thickness dimensions) is greater than five. Nanowires are being employed as conductors in electronic devices or as elements in optical devices, among other possible uses. Silver nanowires are currently preferred in some such applications.

### Feed Composition Comprising Liquids and Solid Contaminants

A common method of preparing nanostructures, such as, for example, nanowires, is the “polyol” process. Such a process is described in, for example, Angew. Chem. Int. Ed. 2009, 48, 60, Y. Xia, Y. Xiong, B. Lim, S. E. Skrabalak, which is hereby incorporated by reference in its entirety. Such processes typically reduce a metal cation, such as, for example, a silver cation, to the desired metal nanostructure product, such as, for example, a silver nanowire. Such a reduction may be carried out in a reaction mixture that may, for example, comprise one or more polyols, such as, for example, ethylene glycol (EG), propylene glycol, butanediol, glycerol, sugars, carbohydrates, and the like; one or more protecting agents, such as, for example, polyvinylpyrrolidinone (also known as polyvinylpyrrolidone or PVP), other polar polymers or copolymers, surfactants, acids, and the like; and one or more metal ions. These and other components may be used in such reaction mixtures, as is known in the art. The reduction may, for example, be carried out at one or more temperatures from about 120° C. to about 190° C.

The product slurries from such processes may comprise the desired high-aspect ratio nanowires, shorter nanowires and other shorter nanostructures, small nanoparticles, polyols, protecting agents, catalyst compounds, and other soluble or insoluble impurities. Such slurries may therefore be characterized as comprising the desired nanowires, at least one liquid comprising one or more solvents and soluble compounds, and one or more solid contaminants. In general, more than one liquid phase may optionally be present, with soluble compounds partitioning among them according to their relative solubilities.

### Cross-Flow Filtration: Feed, Permeate, and Retentate Compositions

Cross-flow filtration, sometimes referred to as tangential-flow filtration, is a common method for clarifying, concentrating, and purifying proteins. See, for example, Protein Concentration and Diafiltration by Tangential Flow Filtration—An Overview, Millipore Technical Brief No. 32, 2003, available at http://www.millipore.com/techpublications/tech1/tb032, which is hereby incorporated by reference in its entirety. Cross-flow filtration has very recently been applied to small-scale nano-wire purification. See K. C. Pradel, K. Sohn, and J. Huang, Ang. Chem. Int. Ed., 2011, 50, 3412-16, which is hereby incorporated by reference in its entirety.

In cross-flow filtration, a fluid or slurry “feed composition” is pumped tangentially through a filter element inlet along a surface of a semi-permeable membrane, where the fluid pressure forces a portion of the fluid or slurry through pores in the membrane to form a “permeate composition,” with the remainder of the fluid or slurry flowing along the membrane surface to a filter element outlet to form a “retentate composition.” Unlike conventional filtration, solids in the retentate are not as likely to build up on the filter medium (i.e., the semi-permeable membrane), because they tend to be swept away to the outlet of the filter element. There is therefore little need to add filtration aids, which would normally need to be separated from the desired nanowires in one or more downstream separation steps.

Cross-flow filtration can be used to remove solid contaminants and/or to replace some or all of the liquid portion of the feed composition with another liquid or liquids. For example, the solid fraction of nanowires in the retentate composition may be greater than the solid fraction of nanowires in the feed composition; or the solid fraction of nanowires in the permeate composition may be less than the solid fraction of nanowires in the feed composition; or at least about 90%, or at least about 95%, or at least about 99% of the liquid in the feed composition may be displaced by another liquid or liquids.

### Filter Elements

Cross-flow filter elements are commonly available as flat-plate filter elements, spiral wound filter elements, or hollow fiber filter elements, as described in the Millipore Technical Brief referenced and incorporated above. Hollow fiber filter elements comprising bundles of hollow membrane tubes are readily available, with tube diameters from about 0.1 to about 2.0 mm. The semi-permeable membranes may be made of a variety of materials that are compatible with nanowire slurries, such as, for example, polyethersulfone or polysulfone. The semi-permeable membrane may have a mean pore diameter of, for example, greater than about 0.05 μm and less than about 0.5 μm, or a mean pore diameter of about 0.2 μm; or a mean pore diameter greater than about 0.01 μm and less than about 0.5 μm, or a mean pore diameter of about 0.02 μm.

### Articles Comprising Nanowires

Nanowires may be incorporated into articles, such as, for example, electronic displays, touch screens, portable telephones, cellular telephones, computer displays, laptop computers, tablet computers, point-of-purchase kiosks, music players, televisions, electronic games, electronic book readers, transparent electrodes, solar cells, light emitting diodes, other electronic devices, medical imaging devices, medical imaging media, and the like. Silver nanowires are currently preferred in some such applications.

### EXEMPLARY EMBODIMENTS

U.S. provisional application No. 61/522,779, filed Aug. 12, 2011, entitled NANOWIRE PURIFICATION METHODS, COMPOSITIONS, AND ARTICLES, which is hereby incorporated by reference in its entirety, disclosed the following twelve non-limiting exemplary embodiments:
A. A method comprising:

providing a feed composition comprising nanowires, at least one first liquid, and at least one solid contaminant;

providing at least one filter element comprising at least one inlet; at least one outlet, at least one semi-permeable membrane comprising a plurality of pores therethrough, said plurality of pores comprising a mean pore diameter less than about 0.5 μm;

feeding the feed composition to the at least one inlet of the at least one filter element; and

producing a retentate composition comprising nanowires from the at least one outlet of the at least one filter element,

wherein the solid fraction of nanowires in the retentate composition is greater than the solid fraction of nanowires in the feed composition.
B. The method according to embodiment A, wherein the at least one filter element comprises at least one of a flat plate filter element, a spiral wound filter element, or a hollow fiber filter element.
C. The method according to embodiment A, further comprising producing a permeate composition comprising material having passed through the plurality of pores of the at least one semi-permeable membrane.
D. The method according to embodiment C, wherein solid fraction of nanowires in the permeate composition is less than the solid fraction of nanowires in the feed composition.
E. The method according to embodiment A, wherein the plurality of pores comprises a mean pore size greater than about 0.05 μm.
F. The method according to embodiment A, wherein the nanowires in the feed composition comprise silver nanowires.
G. The method according to embodiment A, wherein the nanowires in the feed composition comprise a mean length greater than about 10 μm.
H. The method according to embodiment A, further comprising displacing at least some of the at least one first liquid with at least one second liquid.
J. The method according to embodiment A, further comprising displacing at least about 90% of the at least one first liquid with at least one second liquid.
K. The retentate comprising nanowires produced according to the method of embodiment A.
L. The nanowires of the retentate according to embodiment K.
M. An article comprising the nanowires according to embodiment L.

### EXAMPLES

### Methods

Mean nanowire lengths and standard deviations were determined using scanning electron microscopy measurements of 100 wires.

Coating surface resistivity was measured using an R-CHEK™ RC2175 four-point resistivity meter.

Total light transmittance and percent haze were measured using a BYK Gardner Hazegard instrument, according to ASTM method D-1003.

### Example 1 (Comparative)

A filter element (Spectrum Labs MINI-KROSS® M7-M05E-300-F1N) comprising a bundle of 0.5 mm I.D. polyethersulfone hollow fibers having overall surface area of 0.31 m² and mean pore size of 0.5 μm was configured in a 1.5 L/min recirculation loop. The loop feed-point was located upstream of the inlet to the filter element, with the retentate from the filter element being recirculated to the inlet of the filter element and the permeate from the filter element being taken off to a receiver to maintain a constant recirculation loop volume.

1.7 L of a slurry comprising ethylene glycol and silver nanowires having mean length 19.6 μm (std. dev. 9.4 μm) was fed over 7 min to the recirculation loop feed-point, followed by 2.0 L of isopropanol solvent exchange. Afterwards, 0.2 L of retentate was then drained from the recirculation loop.

The retentate was clear, while the permeate in the take-off receiver was cloudy. Essentially all of the silver was lost to the permeate.

### Example 2 (Comparative)

A filter element (Spectrum Labs CELLFLO® PLUS C95E-041-01N) comprising a bundle of 1.0 mm I.D. polyethersulfone hollow fibers having overall surface area of 0.32 m² and mean pore size of 0.5 μm was configured in a 5.6 L/min recirculation loop. The loop feed-point was located upstream of the inlet to the filter element, with the retentate from the filter element being recirculated to the inlet of the filter element and the permeate from the filter element being taken off to a receiver to maintain a constant recirculation loop volume.

A mixture of 2.0 L water and 2.0 L of a slurry comprising ethylene glycol and silver nanowires having mean length 15.5 μm (std. dev. 6.8 μm) was fed over 8 min to the recirculation loop feed-point, followed by 2.0 L of isopropanol solvent exchange. 0.25 L of retentate was then drained from the recirculation loop.

The retentate was nearly clear, while the permeate in the take-off receiver was very cloudy. Most of the silver was lost to the permeate.

### Example 3

A filter element (Spectrum Labs MINI-KROSS® M70S-300-01N) comprising a bundle of 0.5 mm I.D. polysulfone hollow fibers having overall surface area of 0.31 m² and mean pore size of 0.05 μm was configured in a 5.0-5.6 L/min recirculation loop. The loop feed-point was located upstream of the inlet to the filter element, with the retentate from the filter element being recirculated to the inlet of the filter element and the permeate from the filter element being taken off to a receiver to maintain a constant recirculation loop volume.

A mixture of 2.0 L water and 2.0 L of a slurry comprising silver nanowires having mean length 15.5 μm (std. dev. 6.8 μm) and mean diameter 71.5 nm (std. dev. 18.8 nm) was fed over 8 min to the recirculation loop feed-point, followed by 2.0 L of isopropanol solvent exchange. The retentate was then drained from the recirculation loop. An additional 1.0 L of water flush was fed to the system, with the permeate being collected in the take-off receiver and the flush water being drained afterwards from the recirculation loop.

The permeate was clear, with essentially all of the silver remaining in the retentate or subsequent flush water. 91% of the silver fed was recovered in the retentate and 9% was recovered in the flush water, based on dried solids.

### Example 4

A filter element (Spectrum Labs MINI-KROSS PLUS M7-M02E-100-F1N) comprising a bundle of 0.5 mm I.D. polyethersulfone hollow fibers having overall surface area of 0.105 m² and mean pore size of 0.2 μm was configured in a 1.5-2.3 L/min recirculation loop. The loop feed-point was located upstream of the inlet to the filter element, with the retentate from the filter element being recirculated to the inlet of the filter element and the permeate from the filter element being taken off to a receiver to maintain a constant recirculation loop volume.

A mixture of 2.0 L water and 2.0 L of a slurry comprising silver nanowires having mean length 11.1 μm (std. dev. 4.1 μm) and mean diameter 64.5 nm (std. dev. 12 nm) was fed at a rate of 0.09-0.15 L/min to the recirculation loop feed-point, followed by 1.07 L of isopropanol solvent exchange. The retentate was then drained from the recirculation loop. The filter element was then backwashed by pumping 0.2 L isopropanol through the filter element permeate port at 0.185 L/min. An additional 0.5 L of isopropanol flush was fed to the system and drained afterwards from the recirculation loop.

The permeate had a yellow color, indicating the presence of some silver nanoparticles. 73% of the silver fed was recovered in the retentate and 9% was recovered in the isopropanol flush, based on dried solids.

### Example 5

A filter element (Spectrum Labs CELLFLO® PLUS C92E-041-01N) comprising a bundle of 1.0 mm I.D. polyethersulfone hollow fibers having overall surface area of 0.32 m² and mean pore size of 0.2 μm was configured in a 7-9 L/min recirculation loop. The loop feed-point was located upstream of the inlet to the filter element, with the retentate from the filter element being recirculated to the inlet of the filter element and the permeate from the filter element being taken off to a receiver to maintain a constant recirculation loop volume.

A mixture comprising 18.8 L ethylene glycol, 18.8 L water, and 41.1 g silver nanowires having mean length 22.5 μm (std. dev. 14.1 μm) was fed at a rate of 0.6-1.2 L/min to the recirculation loop feed-point, using MASTERFLEX® peristaltic pumps equipped with silicone tubing. This was followed by 20 L of isopropanol solvent exchange using the same pumps. The retentate was then drained from the recirculation loop. The liquid portion of the retentate comprised greater than 99% isopropanol and less than 1% ethylene glycol and water.

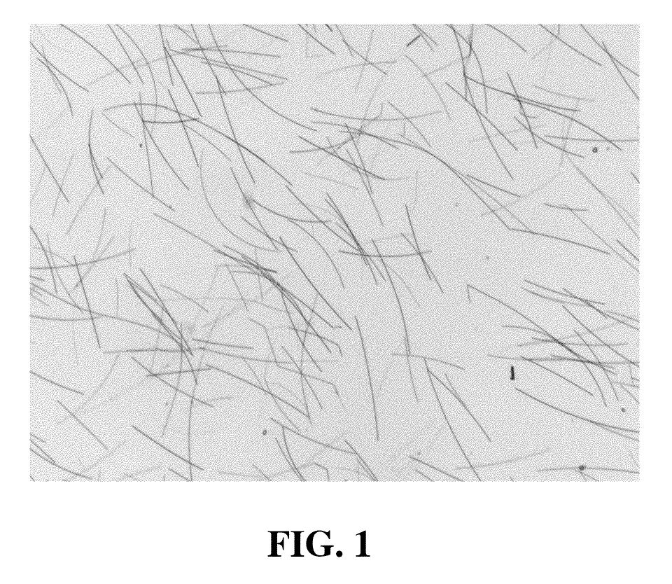

FIG. 1 shows a micrograph of the retentate. The mean nanowire length was 31 μm (std. dev. 14 μm). The cross-flow filtered material contained few nanoparticles or short nanowires.

### Example 6 (Comparative)

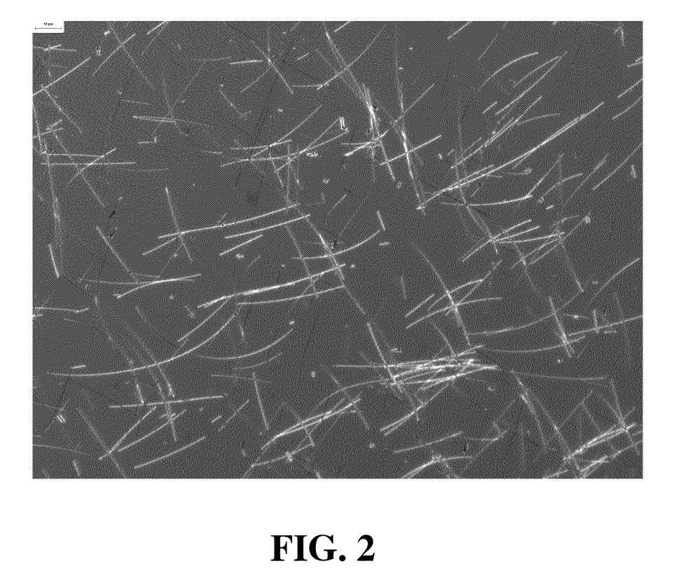

1337 g of a reaction product comprising silver nanowires and ethylene glycol (“Slurry A”) was diluted with an equal volume of acetone. The resulting mixture was centrifuged at 400 G for 45 min. The supernatant was decanted and discarded, with the residue being redispersed in 1.2 L of isopropanol, shaken for 30 min, and centrifuged at 400 G for 45 min. The supernatant was decanted and discarded, with the residue being redispersed in 700 mL isopropanol and shaken for 40 min, and centrifuged at 400 G for 45 min. The supernatant was decanted and discarded, with the residue being redispersed in isopropanol. FIG. 2 shows a micrograph of the resulting dispersion, which had an average nanowire length of 15.1 μm and an average diameter of 99.8 nm.

The resulting dispersion was used in a coating composition to make a transparent coating with surface resistivity of 110-130 ohms/square. The coating had an 86.6% total light transmittance and a haze value of 3.90%.

### Example 7

A filter element (Spectrum Labs CELLFLO® PLUS C92E-041-01N) comprising a bundle of 1.0 mm I.D. polyethersulfone hollow fibers having overall surface area of 0.32 m² and mean pore size of 0.2 μm was configured in a 10-12 L/min recirculation loop. The loop feed-point was located upstream of the inlet to the filter element, with the retentate from the filter element being recirculated to the inlet of the filter element and the permeate from the filter element being taken off to a receiver to maintain a constant recirculation loop volume.

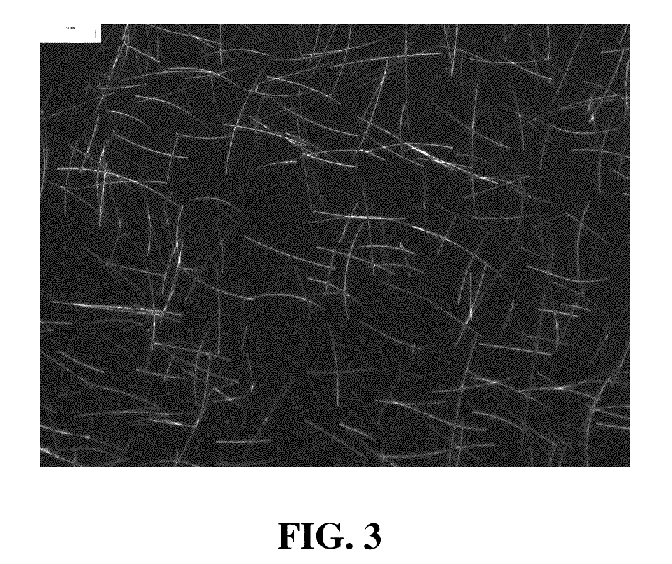

17.5 L of “Slurry A” from Example 6 was mixed with 17.5 L of high purity water. The resulting mixture was fed at a rate of 0.7-1.7 L/min to the recirculation loop feed-point, followed by 18.5 L of isopropanol solvent exchange. The retentate was then drained from the recirculation loop. The filter element was then backwashed by pumping 0.25 L isopropanol through the filter element permeate port. FIG. 3 shows a micrograph of the retentate, which had a mean nanowire length of 30.9 μm. Note that this retentate had fewer short wires and nanoparticles than the centrifuged-purified dispersion of Example 6.

The retentate was used in a coating composition to make a transparent coating with surface resistivity of 100-140 ohms/square. The coating had an 89.2% total light transmittance and a haze value of 3.36%. The optical properties of this coating were superior to those of the Example 6 coating that was based on the centrifuge-purified dispersion.

### Example 8

Two filter elements (Spectrum Labs MINIKROS® PLUS M7-M02E-300-F1N) each comprising a bundle of 1.0 mm I.D. polyethersulfone hollow fibers having overall surface area of 0.31 m² and mean pore size of 0.2 μm, were configured in parallel in a 10-12 L/min recirculation loop. The loop had a volume of 2.76 L and was equipped with a recirculation pump and a 50 mesh (300 micron) woven mesh strainer. The loop feed-point was located upstream of the inlets to the filter elements, with the retentate from the filter elements being recirculated to the inlet of the filter element and the permeate from the filter element being taken off to a receiver to maintain a constant recirculation loop volume. Permeate was withdrawn through a valve set to maintain a permeate flow-rate of 200 mL/min from each of the filter elements. During operation, the pressure upstream of the filter elements was 14 psig.

Three equal aliquots totaling 44 L of a dispersion comprising ethylene glycol and silver nanowires having an average length of 24.2 μm and an average diameter of 60.8 nm was drawn into the recirculation loop at its feed-point. After each aliquot was processed, the concentrated retentate dispersion was drained from the loop as product. After the third aliquot was processed, the loop was filled with water to rinse out residual solids, which were then added to the product. The concentrated dispersion product had been reduced in volume to 11 L. Throughout the processing, the permeate remained clear and colorless, reflecting the absence of nanoparticles therein.

### Example 9

Six filter elements (Spectrum Labs MINIKROS® PLUS N02-E500-05-N), each comprising a bundle of 0.5 mm I.D. polyethersulfone hollow fibers having overall surface area of 0.26 m² and a nominal molecular weight cutoff of 500,000 Daltons, were configured in two parallel banks, with each bank having three elements in series, in a 9-13 L/min recirculation loop. The mean pore size of the filter elements was believed to be about 0.02 μm. The loop had a volume of 3.76 L and was equipped with a recirculation pump and a 50 mesh (300 micron) woven mesh strainer. The loop feed-point was located upstream of the inlets to the filter elements, with the retentate from the filter elements being recirculated to the inlet of the filter element and the permeate from the filter element being taken off to a receiver to maintain a constant recirculation loop volume.

Three permeate takeoff lines were configured. The first was made up of the permeate exiting the upstream pair of filter elements; the second was made up of the permeate exiting the middle pair of filter elements; and the third was made up of the permeate exiting the downstream pair of filter elements. During operation, the pressure upstream of the filter element banks was 24-25 psig and the retentate pressure exiting the filter element banks was 1-2 psig.

A first volume of dispersion comprising 10.5 L propylene glycol, 75 g silver nanowires and nanoparticles, and 159 g polyvinylpyrollidone, was diluted to 25 vol % by the addition of three volumes of water to make a dilute feed dispersion. The nanowires in the dispersion had a number-weighted mean length of 17.7 μm and a number-weighed mean diameter of 38.2 nm.

The dilute feed dispersion was supplied to the loop feed point at a rate sufficient to maintain a constant volume in the recirculation loop. Permeate was withdrawn through valves set to maintain a total flow-rate from each pair of elements of 300 mL/min per pair, or 900 mL/min overall. After all of the dilute feed dispersion had been drawn into the loop, the permeate flow-rates were reduced to 150 mL/min per pair of elements, or 450 mL/min overall. The loop volume was maintained by adding isopropanol until a total of 5 loop volumes of isopropanol had been fed to the system. Afterwards, the concentrated retentate dispersion was drained from the loop as product.

### Example 10

A filter element (Spectrum Labs pre-production filter P-S1-500E-100-01N, similar to current production model MINIKROS® S02-E500-05-N) comprising a bundle of 0.5 mm I.D. polyethersulfone hollow fibers having overall surface area of 0.082 m² and a nominal molecular weight cutoff of 500,000 Daltons was configured in a 75 mL/min recirculation loop. The mean pore size of the filter elements was believed to be about 0.02 μm. The loop feed-point was located upstream of the inlet to the filter element, with the retentate from the filter element being recirculated at a flow-rate of 1-1.4 L/min to the inlet of the filter element and the permeate from the filter element being taken off to a receiver to maintain a constant recirculation loop volume. During operation, the pressure upstream of the filter element was 10-14 psig and the retentate pressure exiting the filter element was 6-9 psig.

A first volume of dispersion comprising 365 g propylene glycol, 1.20 g silver nanowires and nanoparticles, and 4.8 g polyvinylpyrollidone, was diluted to 25 vol % by the addition of three volumes of water to make a dilute feed dispersion. The nanowires in the dispersion had a number-weighted mean length of 14.8 μm and a number-weighed mean diameter of 36.6 nm.

The dilute feed dispersion was supplied to the loop feed point at a rate sufficient to maintain a constant volume in the recirculation loop. Permeate was withdrawn at a rate of 40-50 mL/min. After all of the dilute feed dispersion had been drawn into the loop, the permeate flow-rate was reduced to 23 mL/min. During processing, the permeate was yellow and slightly cloudy, indicating the presence of nanoparticles therein. The loop volume was maintained by adding isopropanol until a total of 5 loop volumes of isopropanol had been fed to the system. Afterwards, the concentrated retentate dispersion was drained from the loop as product.

The nanowires in the concentrated retentate dispersion had a number-weighted mean length of 17.0 μm and a number-weighed mean diameter of 36.6 nm. The length distribution showed a marked decrease in nanowires less than 8 μm in length relative to the feed dispersion. Photomicrographs showed a marked reduction in the number of nanoparticles relative to the feed dispersion.

### Example 11 (Comparative)

Two filter elements (Spectrum Labs MINIKROS® PLUS M7-M02E-300-F1N) each comprising a bundle of 1.0 mm I.D. polyethersulfone hollow fibers having overall surface area of 0.31 m² and mean pore size of 0.2 μm, were configured in parallel in a 10-12 L/min recirculation loop. The loop had a volume of 2.75 L and was equipped with a recirculation pump and a 50 mesh (300 micron) woven mesh strainer. The loop feed-point was located upstream of the inlets to the filter elements, with the retentate from the filter elements being recirculated to the inlet of the filter element and the permeate from the filter element being taken off to a receiver to maintain a constant recirculation loop volume. Permeate was withdrawn without restriction from each filter element.

44 L of a dispersion comprising ethylene glycol and silver nanowires having an average length of 12.8 μm and an average diameter of 50.7 nm was prepared to be drawn into the recirculation loop at its feed-point to replace permeate exiting the loop, maintaining a constant loop volume.

The initial total permeate flow-rate was 900 mL/min per module and the initial circulation flow-rate was 13 L/min. The feed-point pressure rapidly rose to 25 psig, with the inlet flow-rate falling to less than 2 L/min. Shortly thereafter, no permeate flow was detected. Processing of the batch was discontinued.

### Example 12 (Comparative)

Two filter elements (Spectrum Labs MINIKROS® PLUS M7-M02E-300-F1N) each comprising a bundle of 1.0 mm I.D. polyethersulfone hollow fibers having overall surface area of 0.31 m² and mean pore size of 0.2 μm, were configured in parallel in a 10-12 L/min recirculation loop. The loop had a volume of 2.75 L. The loop feed-point was located upstream of the inlets to the filter elements, with the retentate from the filter elements being recirculated to the inlet of the filter element and the permeate from the filter element being taken off to a receiver to maintain a constant recirculation loop volume. Permeate was withdrawn without restriction from each filter element.

A dispersion comprising ethylene glycol and silver nanowires having an average length of 25 μm and an average diameter of 64 nm was prepared to be drawn into the recirculation loop at its feed-point to replace permeate exiting the loop, maintaining a constant loop volume.

The dispersion was supplied to the loop feed point at a rate sufficient to maintain a constant volume in the recirculation loop. Permeate was withdrawn through valves set to maintain a total flow-rate from each of elements of 300 mL/min, or 600 mL/min overall. During processing, the permeate remained clear and colorless, reflecting an absence of nanoparticles therein.

After all of the feed dispersion had been drawn into the loop, the loop volume was maintained by feeding isopropanol to the loop. Within one minute of initiating isopropanol feed, permeate flow fell to zero and processing ceased. The inlets to both filter elements were blocked by agglomerated material.

The invention has been described in detail with reference to particular embodiments, but it will be understood that variations and modifications can be effected within the spirit and scope of the invention. The presently disclosed embodiments are therefore considered in all respects to be illustrative and not restrictive. The scope of the invention is indicated by the appended claims, and all changes that come within the meaning and range of equivalents thereof are intended to be embraced therein.

What is claimed:

1. A method comprising:
providing a first feed composition comprising nanowires, at least one first liquid, and at least one solid contaminant;
providing at least one filter element comprising at least one inlet; at least one outlet, at least one semi-permeable membrane comprising a plurality of pores therethrough, said plurality of pores comprising a mean pore diameter less than about 0.5 μm;
feeding the first feed composition to the at least one inlet of the at least one filter element; and
producing a retentate composition comprising nanowires from the at least one outlet of the at least one filter element,
wherein the solid fraction of nanowires in the retentate composition is greater than the solid fraction of nanowires in the feed composition.

2. The method according to claim 1, wherein the at least one filter element comprises at least one of a flat plate filter element, a spiral wound filter element, or a hollow fiber filter element.

3. The method according to claim 1, wherein the permeate composition comprises material having passed through the plurality of pores of the at least one semi-permeable membrane.

4. The method according to claim 1, wherein the plurality of pores comprises a mean pore size greater than about 0.01 μm.

5. The method according to claim 1, wherein the nanowires in the feed composition comprise silver nanowires comprising a mean length greater than about 10 μm.

6. The method according to claim 1, further comprising displacing at least some of the at least one first liquid with at least one second liquid.

7. The method according to claim 1, wherein producing the retentate composition further comprises controlling at least one retentate flow-rate.

8. The method according to claim 1, further comprising filtering a second feed composition to provide the first feed composition.

9. The retentate comprising nanowires produced according to the method of claim 1.

10. The nanowires of the retentate according to claim 9.
